(19) United States
(12) Patent Application Publication
(10) Pub. No.: US 2010/0180712 A1
(43) Pub. Date: Jul. 22, 2010

(54) DUAL SLIDER ASSEMBLY

(75) Inventor: Jae Kyu Choi, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: AMPHENOL PHOENIX CO., LTD., HWASEONG-SI, GYEONGGI-DO (KR)

(21) Appl. No.: 12/602,132

(22) PCT Filed: May 22, 2008
(86) PCT No.: PCT/KR2008/002860

§ 371 Date: Mar. 25, 2010

(30) Foreign Application Priority Data
May 28, 2007 (KR) 10-2007-0051730

(51) Int. Cl. G05G 11/00

(52) U.S. Cl. 74/490.13

(57) ABSTRACT

A dual slider assembly for a mobile phone is provided which can perform semiautomatic bidirectional sliding operation using a single spring mechanism. The dual slider assembly includes a fixed plate. A first sliding plate is coupled to the fixed plate for sliding movement in a first sliding direction and is formed with a guide slot parallel to a second sliding direction. A second sliding plate is coupled to the first sliding plate for sliding movement in the second sliding direction. The dual slider assembly further includes an elastic means for applying an elastic force to maintain the first sliding plate and the second sliding plate in a stationary state, the elastic means having a first end pivotably secured to the fixed plate and a second end pivotably secured to the second sliding plate and restrained to slide along the guide slot of the first sliding plate.

### FIELD OF THE INVENTION

The present invention relates to a dual slider assembly and, more particularly, to a dual slider assembly which can perform semiautomatic bidirectional sliding operation using a single elastic means.

### BACKGROUND ART

A slider assembly for a dual slide mobile phone is disclosed in Korean Unexamined Patent Publication No. 10-2006-0045514 published on May 17, 2006 and entitled “Sliding Apparatus for Double Sliding-type Portable Communication Device.” Referring to FIG. 6, the slider assembly 50 disclosed in the document includes a first sliding plate 52 which is coupled to a fixed plate 51 to be slidable in a first sliding direction, and a second sliding plate 53 which is coupled to the first sliding plate 52 to be slidable in a second sliding direction. Torsion springs 54 and 55 are installed between the fixed plate 51 and the first sliding plate 52 and between the first sliding plate 52 and the second sliding plate 53 such that the first and second sliding plates 52 and 53 can be slid semiautomatically by the elastic returning force of the torsion springs 54 and 55.

In the conventional slider assembly for a dual slide mobile phone constructed as mentioned above, elastic members (torsion springs) are installed between the fixed plate and the first sliding plate and between the first and second sliding plates to apply a returning force. Thus, the thickness of the slider assembly is increased, making it difficult to make the mobile phone slim. Furthermore, the number of parts is increased due to the installation of the two elastic members, which leads to increased manufacturing costs, complicated assembling process and reduced productivity.

### DETAILED DESCRIPTION OF THE INVENTION

### Technical Problems

It is an object of the present invention to provide a slim dual slider assembly.

Another object of the present invention is to provide a slider assembly for a dual slide mobile phone that can reduce the number of parts to save material costs and simplify an assembling process.

These objects are achieved by providing a slider assembly for a dual slide mobile phone that has a novel technical construction in which the slider assembly can be used semiautomatically by enabling a returning force to be applied bidirectionally using a single elastic means.

### Solution to the Technical Problems

According to the present invention, there is provided a dual slider assembly comprising: a fixed plate; a first sliding plate coupled to the fixed plate for sliding movement in a first sliding direction and formed with a guide slot parallel to a second sliding direction; a second sliding plate coupled to the first sliding plate for sliding movement in the second sliding direction; and an elastic means for applying an elastic force to maintain the first sliding plate and the second sliding plate in a stationary state, the elastic means having a first end pivotably secured to the fixed plate and a second end pivotably secured to the second sliding plate and restrained in such a manner as to slide along the guide slot of the first sliding plate.

The dual slider assembly recited above may further comprise stoppers for restricting sliding movement distances of the first sliding plate and the second sliding plate.

In the dual slider assembly recited above, the first sliding plate may have an accommodating part formed in a region covering the guide slot so that the elastic means can be received in the accommodating part throughout a pivotal movement range of the elastic means.

In the dual slider assembly recited above, the fixed plate may have first guide parts at opposite lengthwise ends thereof, the first guide parts being bent twice toward the first sliding plate so as to form first guide grooves along the first sliding direction. The first sliding plate may have first wing parts at opposite lengthwise ends thereof, the first wing parts being bent toward the fixed plate, and second guide parts at opposite widthwise ends thereof, the second guide parts being bent twice toward the second sliding plate so as to form second guide grooves along the second sliding direction. The second sliding plate may have second wing parts at opposite widthwise ends thereof, the second wing parts being bent toward the first sliding plate. The first wing parts of the first sliding plate may be respectively inserted into and slidably restrained by the first guide grooves of the fixed plate, and the second wing parts of the second sliding plate may be respectively inserted into and slidably restrained by the second guide grooves of the first sliding plate.

The dual slider assembly recited above may further comprise bearing members fitted into a pair of first guide grooves of the fixed plate and a pair of second guide grooves of the first sliding plate to reduce friction generated during sliding movement of the first and second sliding plates.

In the dual slider assembly recited above, the elastic means may comprise: a movable pin having a first end pivotably secured to the second sliding plate and a second end inserted into the guide slot of the first sliding plate for sliding movement along the guide slot; and an elastic member having a first end pivotably secured to the fixed plate and a second end pivotably secured to the movable pin.

In the dual slider assembly recited above, the elastic member may comprise: a first link slider having a first end pivotably secured to the fixed plate; a second link slider having a first end slidably coupled to the first link slider and a second end pivotably secured to the movable pin; and a spring connected to the first link slider and the second link slider for applying a returning force in such a direction as to move the first link slider and the second link slider away from each other.

### Advantageous Effects

Thanks to the above features of the present invention, there is provided a dual slider assembly that can be slid bidirectionally by means of a single elastic means. The helps reduce the number of parts, which leads to reduced manufacturing costs, simplified assembling process and increased productivity. Moreover, it becomes possible to make the slider slim.

### BRIEF DESCRIPTION OF THE DRAWINGS

FIG. 1 is a perspective view illustrating a dual slider assembly in accordance with one embodiment of the present invention.

FIG. 2 is an exploded perspective view of the dual slider assembly shown in FIG. 1.

FIG. 3 is a front view of the dual slider assembly shown in FIG. 1.

FIG. 4 is a front view illustrating the state in which the dual slider assembly according to the present invention is slid in a first sliding direction (an X-axis direction).

FIG. 5 is a front view illustrating the state in which the dual slider assembly according to the present invention is slid in a second sliding direction (a Y-axis direction).

FIG. 6 is an exploded perspective view of a conventional dual slider assembly.

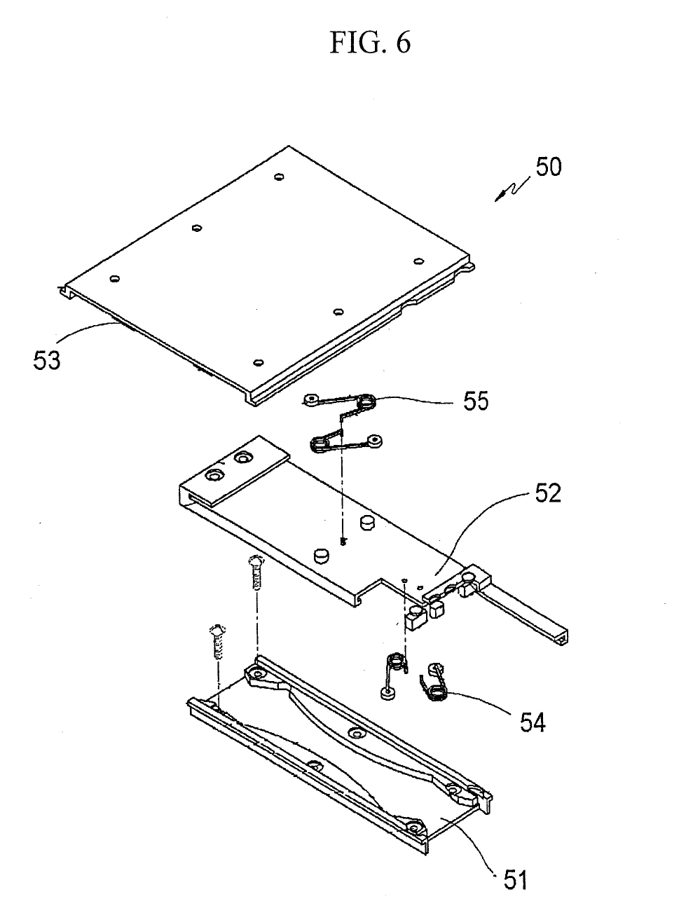

### BEST MODE FOR CARRYING OUT THE INVENTION

A preferred embodiment of the present invention will now be described in detail with reference to the accompanying drawings.

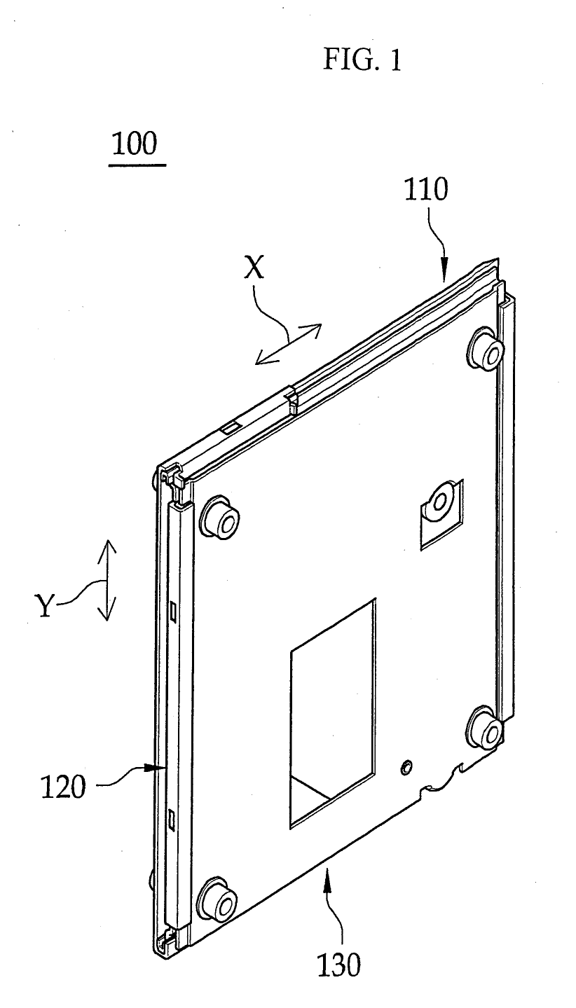

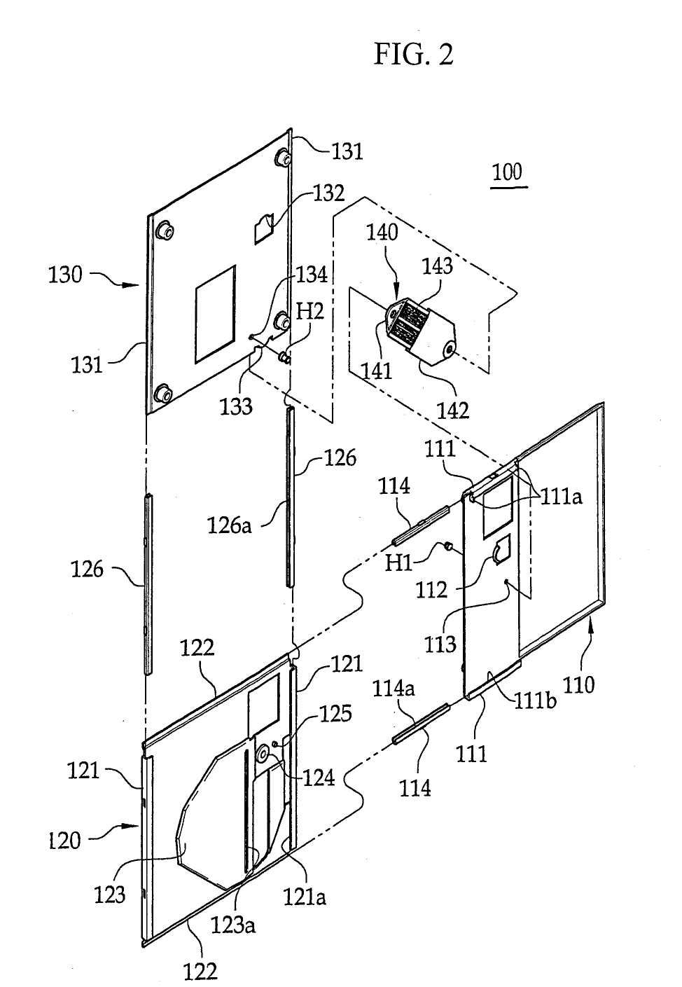

FIG. 1 is a perspective view illustrating a dual slider assembly in accordance with one embodiment of the present invention, and FIG. 2 is an exploded perspective view of the dual slider assembly shown in FIG. 1.

Referring to FIG. 1, a dual slider assembly 100 according to the present embodiment includes a fixed plate 110, a first sliding plate 120 which is coupled to the fixed plate 110 to be slidable in an X-axis direction, and a second sliding plate 130 which is coupled to the first sliding plate 120 to be slidable in a Y-axis direction. These respective plates are manufactured by pressing or injection-molding a metallic material.

Referring to FIG. 2, a pair of first guide parts 111 are formed by being bent twice on both lengthwise ends of the fixed plate 110 which are parallel to the X-axis, such that a pair of first guide grooves 111b are defined in the pair of first guide parts 111 to face each other. A fixed pin hole 113 is defined through the fixed plate 110 between the pair of first guide parts 111. A first stopper 112 is formed on the fixed plate 110 to project inward so as to restrict the sliding distance of the first sliding plate 120. Bearing members 114 made of synthetic resin are respectively fitted into the pair of first guide grooves 111b which are defined by bending the pair of first guide parts 111. Grooves 114a are defined in the bearing members 114 to extend in the lengthwise direction of the bearing members 114. Engagement parts 111a are formed on the opposite ends of the upper first guide part 111 of the fixed plate 110 and are bent to project toward the first sliding plate 120. The engagement parts 111a are to prevent the second sliding plate 130 from sliding in the Y-axis direction while the first sliding plate 120 slides in the X-axis direction.

First wing parts 122 are formed on the opposite lengthwise ends of the first sliding plate 120 parallel to the X-axis and are bent twice toward the fixed plate 110. The first wing parts 122 are slidably inserted into the grooves 114a of the bearing members 114. A pair of second guide parts 121 are formed on the opposite widthwise ends of the first sliding plate 120 parallel to the Y-axis and are bent twice in a direction opposite to the direction in which the first wing parts 122 are bent. As the second guide parts 121 are bent twice, a pair of second guide grooves 121a are defined in the pair of second guide parts 121 to face each other. Bearing members 126 are respectively fitted into the second guide grooves 121a, and grooves 126a are defined in the bearing members 126 to extend in the lengthwise direction of the bearing members 126. A guide slot 123a is defined through the first sliding plate 120 between the pair of second guide parts 121 to extend parallel to the Y-axis and have a predetermined length. An accommodating part 123 is formed in a portion of the first sliding plate 120 which includes the guide slot 123a, such that the accommodating part 123 is depressed in the projecting direction of the second guide parts 121 so as to secure a space for accommodating an elastic means 140 to be installed between the fixed plate 110 and the first sliding plate 120. A second projection 125 for restricting the sliding distance of the first sliding plate 120 in the X-axis direction is formed on the surface of the first sliding plate 120 which faces the fixed plate 110, at the position corresponding to the first stopper 112 of the fixed plate 110. A first projection 124 for restricting the sliding distance of the second sliding plate 130 in the Y-axis direction is formed on the surface of the first sliding plate 120 which faces the second sliding plate 130.

Second wing parts 131 are formed on the opposite widthwise ends of the second sliding plate 130 parallel to the Y-axis and are bent twice toward the first sliding plate 120. The second wing parts 131 are slidably inserted into the grooves 126a which are defined in the bearing members 126 fitted into the second guide grooves 121a of the first sliding plate 120. A movable pin hole 134 is defined through the second sliding plate 130 between the pair of second wing parts 131 at the position corresponding to the guide slot 123a. An upper stopper 132 and a lower stopper 133 are formed on the second sliding plate 130 at the position corresponding to the first projection 124 of the first sliding plate 120 to project toward the first sliding plate 120 so as to restrict the sliding distance of the second sliding plate 130 in the Y-axis direction.

Referring again to FIG. 2, a single elastic member 140 is installed in order to semiautomatically perform the sliding of the first sliding plate 120 in the X-axis direction and the sliding of the second sliding plate 130 in the Y-axis direction. The elastic member 140 is composed of a first link slider 141 and a second link slider 142 which are coupled to each other to be slidable in the lengthwise direction thereof, and a plurality of springs 143 which are connected between the first and second link sliders 141 and 142 to apply an elastic returning force to the respective link sliders 141 and 142. One end of the first link slider 141 is pivotably secured to the fixed pin hole 113 of the fixed plate 110 by a fixed pin H1. One end of the second link slider 142 is pivotably secured to a movable pin H2. One end of the movable pin H2 passes through the guide slot 123a of the first sliding plate 120 and is pivotably secured to the movable pin hole 134 of the second sliding plate 130. The elastic member 140 is installed between the fixed plate 110 and the accommodating part 123 of the first sliding plate 120 to have a slim configuration.

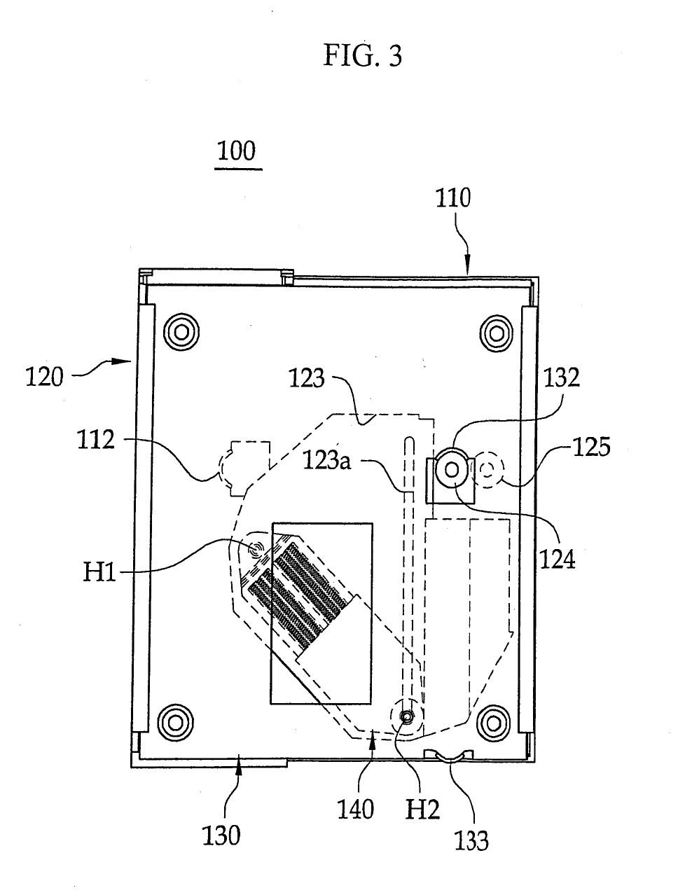

Hereinafter, the operation of the dual slider assembly according to the present embodiment will be described with reference to FIGS. 3 through 5.

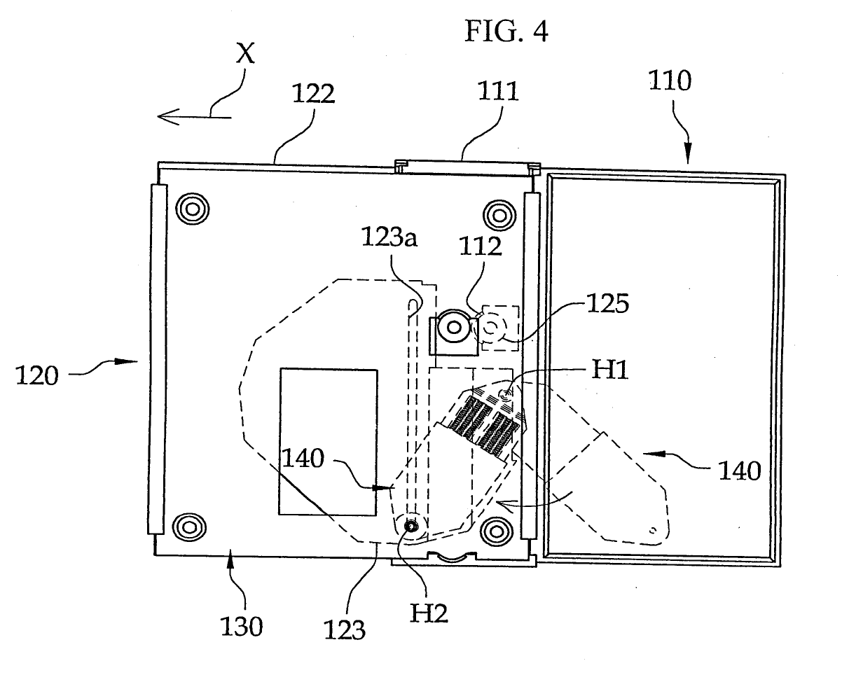

FIG. 3 is a front view illustrating the assembled state of the dual slider assembly according to the present embodiment. If an external force is applied to the first sliding plate 120 relative to the fixed plate 110 in the leftward direction, the first wing parts 122 of the first sliding plate 120 slide in the direction indicated by an arrow in FIG. 4 (the X-axis direction) while guided by the first guide parts 111 of the fixed plate 110. At this time, the elastic member 140 contracts and pivots clockwise as shown in FIG. 4. As the elastic member 140 expands after passing through a maximum contraction point, the first sliding plate 120 continues to slide by the returning force of the springs 143 even without further applying an external force. The sliding movement of the first sliding plate 120 is stopped when the second projection 125 engages with the first stopper 112.

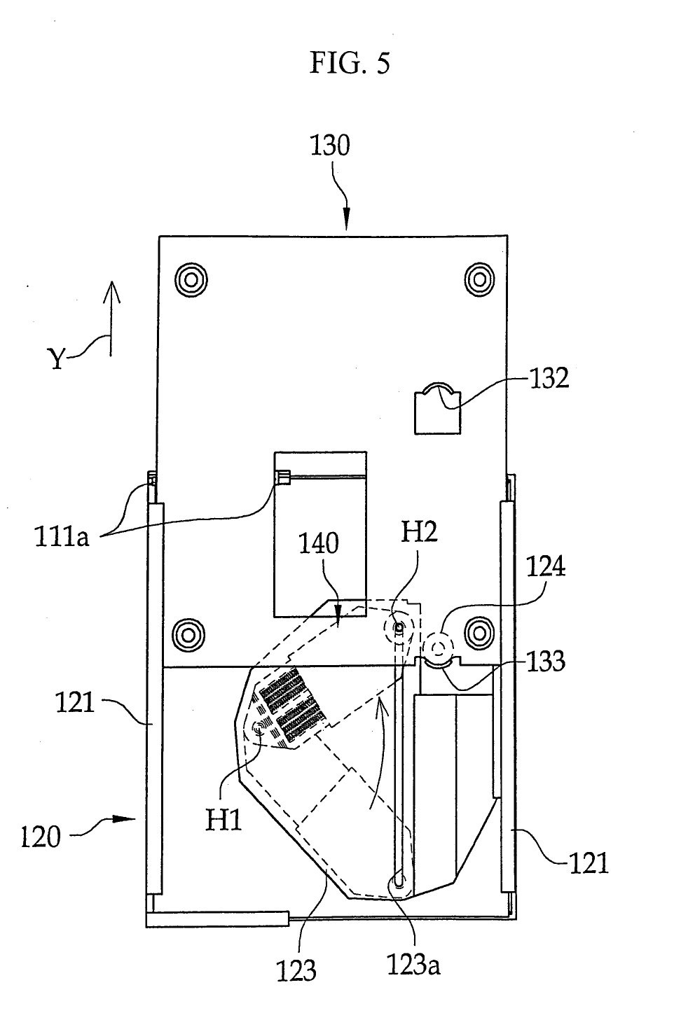

Referring to FIG. 5, if an external force is applied to the second sliding plate 130 relative to the fixed plate 110 in the upward direction, the second sliding plate 130 slides in the upward direction (the Y-axis direction) while guided by the second guide parts 121 of the first sliding plate 120. At this time, the elastic member 140 contracts and pivots counterclockwise as shown in FIG. 5. As the elastic member 140 expands after passing through a maximum contraction point, the second sliding plate 130 continues to slide by the returning force of the springs 143 even without further applying an external force. The sliding movement of the second sliding plate 130 is stopped when the lower stopper 133 engages with the first projection 124.

The embodiment shown and described hereinabove should not be construed to limit the scope of protection of the present invention. The scope of the invention shall be limited only by the subject matters recited in the claims. It will be understood by those skilled in the art that various changes and modifications may be made without departing from the scope of the invention defined in the claims.

### INDUSTRIAL APPLICABILITY

The dual slider assembly in accordance with the present invention is capable of performing semiautomatic bidirectional sliding operation using a single elastic means. The dual slider assembly can find its application in the field of mobile phones and so forth.

1. A dual slider assembly comprising:
a fixed plate;
a first sliding plate coupled to the fixed plate for sliding movement in a first sliding direction and formed with a guide slot parallel to a second sliding direction;
a second sliding plate coupled to the first sliding plate for sliding movement in the second sliding direction; and
an elastic means for applying an elastic force to maintain the first sliding plate and the second sliding plate in a stationary state, the elastic means having a first end pivotably secured to the fixed plate and a second end pivotably secured to the second sliding plate and restrained in such a manner as to slide along the guide slot of the first sliding plate.

2. The dual slider assembly as recited in claim 1, further comprising:
stoppers for restricting sliding movement distances of the first sliding plate and the second sliding plate.

3. The dual slider assembly as recited in claim 1, wherein the first sliding plate has an accommodating part formed in a region covering the guide slot so that the elastic means can be received in the accommodating part throughout a pivotal movement range of the elastic means.

4. The dual slider assembly as recited in claim 3, wherein the fixed plate has first guide parts at opposite lengthwise ends thereof, the first guide parts being bent twice toward the first sliding plate so as to form first guide grooves along the first sliding direction;
wherein the first sliding plate has first wing parts at opposite lengthwise ends thereof, the first wing parts being bent toward the fixed plate, and second guide parts at opposite widthwise ends thereof, the second guide parts being bent twice toward the second sliding plate so as to form second guide grooves along the second sliding direction;
wherein the second sliding plate has second wing parts at opposite widthwise ends thereof, the second wing parts being bent toward the first sliding plate; and
wherein the first wing parts of the first sliding plate are respectively inserted into and slidably restrained by the first guide grooves of the fixed plate, and the second wing parts of the second sliding plate are respectively inserted into and slidably restrained by the second guide grooves of the first sliding plate.

5. The dual slider assembly as recited in claim 4, further comprising: bearing members fitted into a pair of first guide grooves of the fixed plate and a pair of second guide grooves of the first sliding plate to reduce friction generated during sliding movement of the first and second sliding plates.

6. The dual slider assembly as recited in claim 1, wherein the elastic means comprises:
a movable pin having a first end pivotably secured to the second sliding plate and a second end inserted into the guide slot of the first sliding plate for sliding movement along the guide slot; and
an elastic member having a first end pivotably secured to the fixed plate and a second end pivotably secured to the movable pin.

7. The dual slider assembly as recited in claim 6, wherein the elastic member comprises:
a first link slider having a first end pivotably secured to the fixed plate;
a second link slider having a first end slidably coupled to the first link slider and a second end pivotably secured to the movable pin; and
a spring connected to the first link slider and the second link slider for applying a returning force in such a direction as to move the first link slider and the second link slider away from each other.

8. The dual slider assembly as recited in claim 3, wherein the elastic means comprises:
a movable pin having a first end pivotably secured to the second sliding plate and a second end inserted into the guide slot of the first sliding plate for sliding movement along the guide slot; and
an elastic member having a first end pivotably secured to the fixed plate and a second end pivotably secured to the movable pin.

9. The dual slider assembly as recited in claim 4, wherein the elastic means comprises:
a movable pin having a first end pivotably secured to the second sliding plate and a second end inserted into the guide slot of the first sliding plate for sliding movement along the guide slot; and
an elastic member having a first end pivotably secured to the fixed plate and a second end pivotably secured to the movable pin.

10. The dual slider assembly as recited in claim 9, wherein the elastic member comprises:
a first link slider having a first end pivotably secured to the fixed plate;
a second link slider having a first end slidably coupled to the first link slider and a second end pivotably secured to the movable pin; and
a spring connected to the first link slider and the second link slider for applying a returning force in such a direction as to move the first link slider and the second link slider away from each other.
